(19) United States
(12) Patent Application Publication
(10) Pub. No.: US 2003/0125463 A1
(43) Pub. Date: Jul. 3, 2003

(54) Fluoroelastomer composition

(75) Inventors: Haruyoshi Tatsu, Hitachi-shi (JP); Satoru Saito, Kitaibaraki-shi (JP); Sunao Ikeda, Kitaibaraki-shi (JP)

Correspondence Address: Kent E. Baldauf, Webb Ziesenheim Logsdon Orkin & Hanson, P.C., 700 Koppers Building, 436 Seventh Avenue, Pittsburgh, PA, 15219-1818, US

(73) Assignee: Nippon Mektron, Ltd.

(21) Appl. No.: 10/292,689

(22) Filed: Nov. 12, 2002

Related U.S. Application Data
(63) Continuation of application No. 09/495,525, filed on Jan. 31, 2000, now abandoned.

(30) Foreign Application Priority Data
Feb. 1, 1999 (JP) 24343/1999
Jan. 19, 2000 (JP) 10484/2000

(51) Int. Cl. C08L 83/00

(52) U.S. Cl. 525/101; 525/102; 525/326.3; 525/359.3; 525/382; 524/423; 524/430; 523/209

(57) ABSTRACT

A fluoroelastomer composition comprising (1) a fluoroelastomer consisting essentially of tetrafluoroethylene units, perfluoro(alkyl vinyl ether) units and cyano group containing perfluorovinyl ether units; (2) a specified silane coupling agent; (3) a crosslinking agent and (4) an inorganic filler. This fluoroelastomer composition enables improving the moldability of a crosslinkable composition containing an inorganic filler other than carbon black.

### FIELD OF THE INVENTION

The present invention relates to a fluoroelastomer composition. More particularly, the present invention relates to a crosslinkable composition comprising a fluoroelastomer having a cyano group as a crosslinkable group, a crosslinking agent, an inorganic filler and an organosilicon compound.

### BACKGROUND OF THE INVENTION

Japanese Patent Laid-open Publication No. 8(1996)-120144 describes a fluoroelastomer composition comprising a terpolymer of tetrafluoroethylene, a perfluoro(alkyl vinyl ether) and a cyano group containing perfluorovinyl ether represented by the general formula:

CF₂═CFO(CF₂)ₙOCF(CF₃)CN (n: 2-5)

and, as a crosslinking agent, a bis(aminophenyl) compound represented by the general formula:

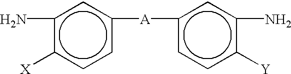

wherein A represents an alkylidene group having 1 to 6 carbon atoms or a perfluoroalkylidene group having 1 to 10 carbon atoms, and each of X and Y represents a hydroxyl group or an amino group.

Japanese Patent Laid-open Publication No. 9(1997)-31284 describes a fluoroelastomer composition comprising a terpolymer of tetrafluoroethylene, a perfluoro(alkyl vinyl ether) and a cyano group containing perfluorovinyl ether and, as a crosslinking agent, a bisamidoxime compound represented by the general formula:

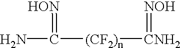

wherein n is an integer of 1 to 10.

These crosslinkable compositions are preferably filled with carbon black, whereby a molding with enhanced mechanical properties can be provided. Although the crosslinkable compositions can be filled with inorganic fillers other than carbon black, it occurs that, with respect to moldability, less desirable results than in the filling of carbon black can be attained thereby.

### OBJECT OF THE INVENTION

The present invention is intended to solve the above problem, and an object of the present invention is to attain striking improvement of the moldability of a crosslinkable composition comprising a terpolymer of tetrafluoroethylene, a perfluoro(alkyl vinyl ether) and a cyano group containing perfluorovinyl ether, a crosslinking agent and an inorganic filler other than carbon black.

### SUMMARY OF THE INVENTION

According to the present invention, for solving the above problem, there is provided a fluoroelastomer composition comprising:

1) a fluoroelastomer consisting essentially of tetrafluoroethylene units, perfluoro(alkyl vinyl ether) units and cyano group containing perfluorovinyl ether units, provided that the alkyl of the perfluoro(alkyl vinyl ether) has 1 to 5 carbon atoms;

2) at least one silane coupling agent selected from among compounds represented by the following general formula (I) or (II):

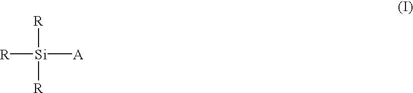

wherein each of R represents an alkoxy or alkyl group having 1 to 5 carbon atoms, the alkoxy or alkyl group having a chain in which at least one ether bond may be contained, provided that at least two of the R are alkoxy groups, and

A represents an alkyl group having 1 to 10 carbon atoms, to which at least one functional group selected from the group consisting of an amino group, a mercapto group, an epoxy group, a vinyl group, a methacryloxy group and halogens is bonded,

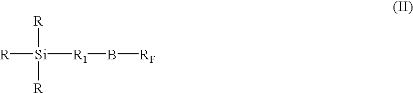

wherein each of R represents an alkoxy or alkyl group having 1 to 5 carbon atoms, the alkoxy or alkyl group having a chain in which at least one ether bond may be contained, provided that at least two of the R are alkoxy groups,

R₁ represents an alkylene group having 1 to 10 carbon atoms, optionally containing a sulfide group, an ether group or a nitrogen atom bonded with a carbonyl group or sulfonyl group, the carbonyl or sulfonyl group having a chain optionally containing R_{F} defined below,

B represents:

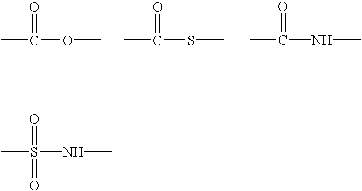

or a carbon to carbon bond directly bonding R₁ with R_{F}, and

R_{F} is a perfluoroalkyl group having 1 to 10 carbon atoms;

3) a crosslinking agent; and

4) an inorganic filler.

It is preferred that the above crosslinking agent be a compound represented by any one of the following general formulae (III) to (VI):

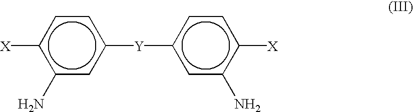

wherein Y represents an alkylidene group having 1 to 6 carbon atoms, a perfluoroalkylidene group having 1 to 10 carbon atoms, a group of the formula —SO—, —O— or —C(═O)—, or a carbon to carbon bond directly bonding two benzene rings together, and X represents a hydroxyl group or an amino group;

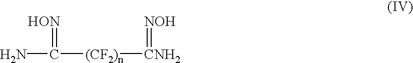

wherein n is an integer of 1 to 10;

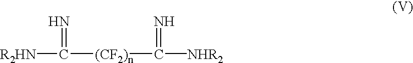

wherein R₂ represents H or NH₂, and n is an integer of 1 to 10; and

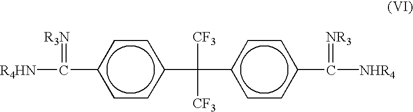

wherein R₃ represents OH or H. and R₄ represents H or NH₂.

The inorganic filler is preferably at least one member selected from the group consisting of titanium dioxide, ferric oxide, zinc oxide, magnesium oxide, aluminum oxide, silicon dioxide, calcium silicate, aluminum silicate, magnesium silicate, barium sulfate, calcium sulfate, calcium carbonate, magnesium carbonate and barium carbonate.

### DETAILED DESCRIPTION OF THE INVENTION

The fluoroelastomer composition of the present invention will be described in detail below.

The fluoroelastomer composition comprises a fluoroelastomer, a specified organosilicon compound, a crosslinking agent and an inorganic filler.

The fluoroelastomer is a terpolymer of tetrafluoroethylene, either a perfluoro(alkyl vinyl ether) or a perfluoro(alkoxyalkyl vinyl ether) and a cyano group containing perfluorovinyl ether, provided that the alkyl or alkoxy of the perfluoro(alkyl vinyl ether) and perfluoro (alkoxyalkyl vinyl ether) has 1 to 5 carbon atoms. Preferred use is made of those obtained by copolymerizing 50 to 75 mol %, especially 60 to 75 mol %, of tetrafluoroethylene and 49.8 to 24.8 mol %, especially 39.8 to 24.8 mol %, of either a perfluoro(alkyl vinyl ether) or a perfluoro(alkoxyalkyl vinyl ether) together with 0.2 to 5 mol %, especially 0.5 to 2 mol %, of a cyano group containing perfluorovinyl ether as a crosslinking moiety monomer.

Perfluoro(methyl vinyl ether), perfluoro(ethyl vinyl ether) or perfluoro(propyl vinyl ether) is preferably used as the perfluoro(alkyl vinyl ether).

Perfluoro (methyl vinyl ether) is still preferably used as the perfluoro(alkyl vinyl ether).

As for the perfluoro (alkoxyalkyl vinyl ether), for example,

CF₂═CFOCF₂CF(CF₃)OCₙF₂ₙ₊₁ (n:1-5)

CF₂═CFO(CF₂)₃OCₙF₂ₙ₊₁ (n:1-5)

CF₂═CFOCF₂CF(CF₃)O(CF₂O)ₘCₙF₂ₙ₊₁ (n:1-5 and m:1-3)

or

CF₂═CFO(CF₂)₂OCₙF₂ₙ₊₁ (n:1-5)

is used .

For example, the following compounds are used as the cyano group containing perfluorovinyl ether:

CF₂═CFO(CF₂)ₙOCF(CF₃)CN (n: 2-4)

CF₂═CFO(CF₂)ₙCN (n: 2-12)

described in U.S. Pat. No. 3,546,186,

CF₂═CFO(CF₂CF(CF₃)Oₘ(CF₂)ₙCN (n:2 and m:1-5)

described in U.S. Pat. No. 4,138,426,

CF₂═CFO(CF₂CF(CF₂CF(CF₃)O)ₘ(CF₂)ₙCN (n: 1-4and m: 1-2)

described in U.S. Pat. No. 4,281,092, and

CF₂═CFO(CF₂CF(CF₃)O)ₙCF₂CF(CF₃)CN (n: 0-4)

described in U.S. Pat. Nos. 3,852,326 and 3,933,767.

As the silane coupling agent, there can be mentioned at least one silane coupling agent selected from among compounds represented by the following general formula (I) or (II):

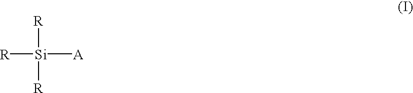

wherein each of R represents an alkoxy or alkyl group having 1 to 5 carbon atoms, the alkoxy or alkyl group having a chain in which at least one ether bond may be contained, provided that at least two of the R are alkoxy groups, and

A represents an alkyl group having 1 to 10 carbon atoms, to which at least one functional group selected from the group consisting of an amino group, a mercapto group, an epoxy group, a vinyl group, a methacryloxy group and halogens is bonded,

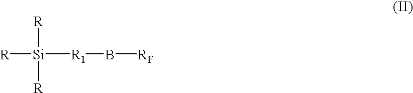

wherein each of R represents an alkoxy or alkyl group having 1 to 5 carbon atoms, the alkoxy or alkyl group having a chain in which at least one ether bond may be contained, provided that at least two of the R are alkoxy groups,

R₁ represents an alkylene group having 1 to 10 carbon atoms, optionally containing a sulfide group, an ether group or a nitrogen atom bonded with a carbonyl group or sulfonyl group, the carbonyl or sulfonyl group having a chain optionally containing R_{F} defined below,

B represents:

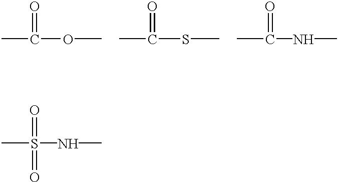

or a carbon to carbon bond directly bonding R₁ with R_{F}, and

R_{F} is a perfluoroalkyl group having 1 to 10 carbon atoms.

Examples of the silane coupling agents include:

aminosilanes such as γ-aminopropyltrimethoxysilane, γ-aminopropyltriethoxysilane, N-phenyl-γ-aminopropyltrimethoxysilane, N-methyl-γ-aminopropyltrimethoxysilane, N-β-(aminoethyl)-γ-aminopropyltrimethoxysilane, N-β-(aminoethyl)-γ-aminopropylmethyldimethoxysilane and 3-ureidopropyltrimethoxysilane;

mercaptosilanes such as γ-mercaptopropyltrimethoxysilane, γ-mercaptopropyltriethoxysilane and γ-mercaptopropylmethyldimethoxysilane;

vinylsilanes and methacryloxysilanes such as vinyltrimethoxysilane, vinyltriethoxysilane, vinyltris(β-methoxyethoxy)silane and γ-methacryloxytrimethoxysilane;

chlorosilanes such as γ-chloropropyltrimethoxysilane and γ-chloropropylmethyldimethoxysilane;

epoxysilanes such as β-(3,4-epoxycyclohexyl)ethyltrimethoxysilane, γ-glycidoxypropyltrimethoxysilane and γ-glycidoxypropylmethyldimethoxysilane; and

compounds of the formulae:

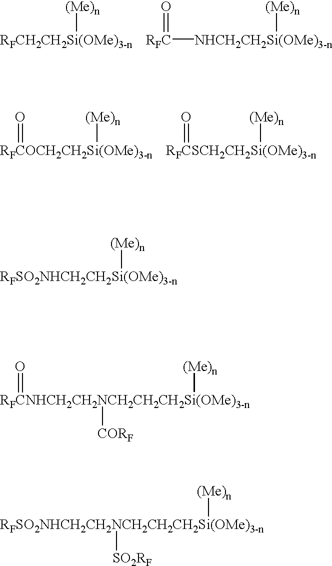

wherein n is 0-1, and R_{F} represents a perfluoroalkyl group having 1 to 10 carbon atoms.

At compounding, when a direct compounding is performed, 0.2 to 3 parts by weight, preferably 0.5 to 2 parts by weight, of silane coupling agent is used per 100 parts by weight of the above terpolymer.

Instead, the silane coupling agent may be incorporated by treating the surface of an inorganic (inorg.) filler with the silane coupling agent and compounding the treated inorganic filler with the above terpolymer. In this method, the required amount (req. amt.) of silane coupling agent is calculated by the formula:

Req. amt. of silane coupling agent=[sp. surface area (m²/g) of inorg. filler×wt. (g) of inorg. filler]/(sp. surface area (m²/g) of silane coupling agent]. (The term “sp.” represents “specific”. The term “wt.” represents “weight”).

However, when the above formula includes unknown parameter, the silane coupling agent is used in an amount of 0.2 to 3 parts by weight, preferably 0.2 to 1 part by weight per inorganic filler.

The treatment of the inorganic filler with the silane coupling agent is most generally performed by the dry method, in which a separately prepared aqueous solution of silane coupling agent or solution of silane coupling agent in an organic solvent such as an alcohol is added to the inorganic filler satisfactorily agitated in, for example, Henschel mixer, and is uniformly dispersed and dried.

Alternatively, the treatment of the inorganic filler with the silane coupling agent may be performed by the slurry method or the spray method.

The inorganic filler is preferably at least one member selected from the group consisting of titanium dioxide, ferric oxide, zinc oxide, magnesium oxide, aluminum oxide, silicon dioxide, calcium silicate, aluminum silicate, magnesium silicate, barium sulfate, calcium sulfate, calcium carbonate, magnesium carbonate and barium carbonate.

The inorganic filler is compounded in an amount of 1 to 50 parts by weight, preferably 5 to 30 parts by weight, per 100 parts by weight of terpolymer.

The compound represented by the following general formula (III) or (IV) can be used as the crosslinking agent:

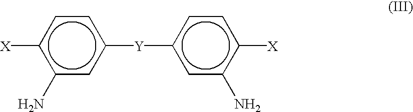

wherein Y represents an alkylidene group having 1 to 6 carbon atoms, a perfluoroalkylidene group having 1 to 10 carbon atoms, a group of the formula —SO₂—, —O— or —C(═O)—, or a carbon to carbon bond directly bonding two benzene rings together, and X represents a hydroxyl group or an amino group; and

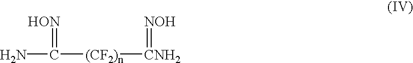

wherein n is an integer of 1 to 10.

Further, the compound represented by the following general formula (V) or (VI) can be used as the crosslinking agent:

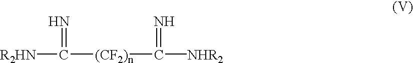

wherein R₂ represents H or NH₂, and n is an integer of 1 to 10,

that is,

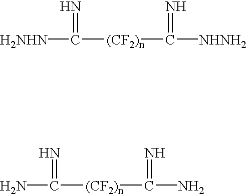

wherein n is an integer of 1 to 10; and

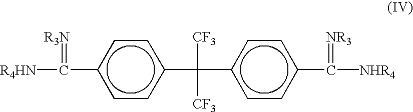

wherein R₃ represents OH or H, and R₄ represents H or NH₂,

preferably,

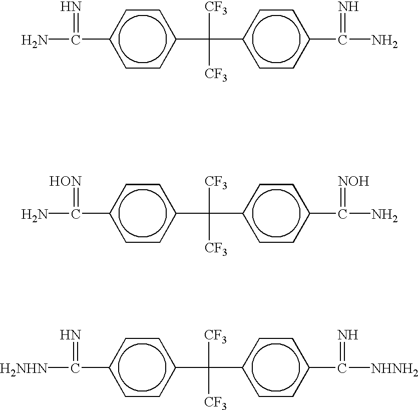

These crosslinking agents are used in an amount of 0.2 to 3 parts by weight, preferably 0.5 to 2 parts by weight, per 100 parts by weight of the above terpolymer.

The fluoroelastomer composition comprising the above components as essential ingredients can appropriately be loaded with a processing auxiliary, a plasticizer and other optionally needed compounding agents.

This composition can be prepared by compounding the compounding agents by the use of, for example, a twin roll mill at 20 to 80° C., preferably 30 to 60° C. The crosslinking of the composition is carried out by heating at 150 to 250° C., preferably 170 to 220° C., for 5 to 60 min, preferably 10 to 30 min, by means of, for example, a compression molding machine. For enhancing the properties of molded articles, it is generally preferred that the molding of the composition be subjected to oven vulcanization performed in air or an inert atmosphere at 150 to 320° C., preferably 200 to 300° C., for about 10 to 50 hr.

### EFFECT OF THE INVENTION

The present invention enables improving the moldability of the cyano group containing fluoroelastomer compounded with an inorganic filler by virtue of the use of the silane coupling agent in combination with the crosslinking agent at the time of crosslinking thereof.

In particular, striking vulcanization accelerating effect is recognized when the aminosilane is used as the silane coupling agent. The use of the aminosilane is thus suitable to the system compounded with a large amount of inorganic filler.

The color shading appearing on the surface of a molding after oven vulcanization is obviated by the use of silane compound having reducing activity, for example, the aminosilane, mercaptosilane or vinylsilane, as the silane coupling agent.

When use is made singly of the crosslinking agent of the general formula (III), a molded article thus obtained exhibits strongly green and color shading such as green streaks. By the combination of the corsslinking agent with the silane coupling agent having reducing activity, whole color of the article becomes ivory, and the color shading is obviated.

The silane coupling agent compounded into the composition of the present invention also functions as an internal additive mold release agent to thereby improve the mold release properties of the composition at the time of molding thereof.

### EXAMPLE

The present invention will further be illustrated below with reference to the following Examples which in no way limit the scope of the invention.

Fluoroelastomer compositions were prepared from the following compounding agents by the use of the following method.

Compounding agent
fluoroelastomer (polymer ML₁₊₁₀ (150° C.): 63 pts)

| | | |
|---|---|---|
| tetrafluoroethylene | 63.9 | mol % |
| perfluoro (methyl vinyl ether) | 30.0 | mol % |
| perfluoro (2-cyano-3, 7-dioxa-8-nonene) | 1.1 | mol %. |

This fluoroelastomer was produced by the method disclosed in Japanese Patent Laid-open Publication No. 8(1996)-120144.

crosslinking agent A

2,2-bis(3-amino-4-hydroxyphenyl)hexafluoropropane.

crosslinking agent B

2,2,3,3,4,4,5,5-octafluorohexanediamidoxime.

wollastonite (1)

Nyad™400 produced by Nyco Minerals, Inc.

Wollastonite (2)

Nyad™G Wollastocoat produced by Nyco Minerals, Inc.

barium sulfate

BC produced by Sakai Chemical Industry Co., Ltd.

silicon dioxide (1)

Carplex™1120 produced by Shionogi & Co., Ltd.

silicon dioxide (2)

Aerosil™200 produced by Degussa.

titanium (IV) oxide

CR-93 produced by Ishihara Sangyo Kaisha, Ltd.

iron (III) oxide

Brown401 produced by Resinocolor Kogyo.

γ-aminopropyltrimethoxysilane

A-1100 produced by Nippon Unicar co., Ltd.

vinyltris(β-methoxyethoxy)silane

A-172 produced by Nippon Unicar Co., Ltd.

γ-mercaptopropyltrimethoxysilane

A-189 produced by Nippon Unicar Co., Ltd.

γ-perfluoro({1-(1-methyl-2-propoxy)ethoxy}propionyl)aminopropyltrimethoxysilane A-1100(R_{F}).

This A-1110(R_{F}), ((CH₃O)₃Si(CH₂)₃NHCOCF (CF₃)OCF(CF₃)CF₂OCF₂CF₂CF₃), was synthesized from A-1100 and methyl perfluoro-2,5-dimethyl-3,6-dioxanonanoate (MeOCOCF(CF₃)OCF(CF₃)CF₂OCF₂CF₂CF₃).

Moreover, in the present invention, the inorganic filler was dry blended with the above silane compound before being compounded into the composition.

Preparation of Composition

As specified in Tables 1 and 2, compounds were obtained by blending 100 parts by weight of perfluoropolymer with the crosslinking agent optionally together with other compounding agents by means of a twin roll mill at 40 to 60° C.

The compounds thus obtaiend were compression molded for 15 min into desired crosslinking products. The crosslinking temperature was 220° C. in the use of crosslinking agent A and 190° C. in the use of crosslinking agent B.

These were further subjected to oven vulcanization performed in a nitrogen atmosphere under the following temperature conditions.

The temperature was:

maintained at 90° C. for 4 hr,

raised to 204° C. over a period of 6 hr,

maintained at 204° C. for 18 hr,

raised to 288° C. over a period of 6 hr,

maintained at 288° C. for 18 hr, and

lowered to 100° C. over a period of 2 hr.

Method of Testing

The following tests were conducted to evaluate the properties of the obtained fluoroelastomer compositions.

Compound curing test

ODR (amplitude angle 1°) according to JIS K6300.

Testing of properties of curing products

tensile test according to DIN53504,

hardness according to DIN53505, and

compression set according to ASTM D395, Method B.

In Examples 13 and 14 and Comparative Example 5, furthermore, not only the visual inspection of appearance of molded items but also the following tests were performed:

In-air heat aging test

according to DIN53508, and

Oil resistance test

Immersion in specified oil was followed by measurements according to DIN53504 and DIN53505.

TABLE 1

| | | Example | Example | Example | Example |
|---|---|---|---|---|---|
| Composition | | 1 | 2 | 3 | 4 |
| fluoroelastomer | | 100 | 100 | 100 | 100 |
| curing agent A | | 1.4 | 1.4 | 1.4 | 1.4 |
| barium sulfate | | 10 | | | |
| wollastonite (1) | | | 10 | | |
| wollastonite (2) | | | | | 10 |
| silicon dioxide (1) | | | | | |
| silicon dioxide (2) | | | | 5 | |
| titanium (IV) oxide | | | | | |
| iron (III) oxide | | | | | |
| curing agent B | | | | | |
| γ-aminopropyltri- | | 1 | 1 | 1 | |
| methoxysilane | | | | | |
| vinyltris (β-methoxy- | | | | | |
| ethoxy) silane | | | | | |
| γ-mercaptopropyltri- | | | | | |
| methoxysilane | | | | | |
| ODR (24 min) @/° C. | | 220 | 220 | 220 | 220 |
| M_{L} | kg-cm | 32 | 32 | 32 | 32 |
| M_{H} | kg-cm | 40 | 44 | 44 (M_{H}^{∞}) | 49 (M_{H}^{∞}) |
| tₛ₂ | min | 1.0 | 1.2 | 1.6 | 5.4 |
| t_{c10} | min | 0.8 | 0.9 | 1.2 | 5.0 |
| t_{c90} | min | 5.0 | 16.0 | 15.4 | 20.8 |

Mechanical properties

| M₁₀₀ | MPa | 3.9 | 6.4 | 6.4 | 6.5 |
|---|---|---|---|---|---|
| T_{b} | MPa | 13.7 | 17.0 | 18.3 | 17.9 |
| E_{b} | % | 200 | 190 | 180 | 190 |
| hardness pts | | 70 | 72 | 73 | 70 |
| Compression set % | | | | | |
| 250° C., | 70 hr | 33 | 32 | 36 | 17 |
| 275° C., | 70 hr | 36 | 37 | 39 | 19 |
| 295° C., | 70 hr | 44 | 44 | 48 | 25 |

hot water resistance
test (200° C., 70 hr)
hardness change

| (IRHD) pts | | −4 | −1 | 0 | −1 |
|---|---|---|---|---|---|
| volume increase % | | +3.4 | +0.9 | +2.4 | +1.6 |
| | | Example | Example | Example | Example |
| Composition | | 5 | 6 | 7 | 8 |
| fluoroelastomer | | 100 | 100 | 100 | 100 |
| curing agent A | | 1.4 | | 1.4 | 1.4 |
| barium sulfate | | | | | |
| wollastonite (1) | | | | | |
| wollastonite (2) | | 10 | | | |
| silicon dioxide (1) | | | | | |
| silicon dioxide (2) | | | | | |
| titanium (IV) oxide | | | 10 | | |
| iron (III) oxide | | | | 10 | 10 |
| curing agent B | | | 1 | | |
| γ-aminopropyltri- | | 1 | 1 | | |
| methoxysilane | | | | | |
| vinyltris (β-methoxy- | | | | | 1 |
| ethoxy) silane | | | | | |
| γ-mercaptopropyltri- | | | | | |
| methoxysilane | | | | | |
| ODR (24 min) @/° C. | | 220 | 190 | 220 | 220 |
| M_{L} | kg-cm | 32 | 30 | 24 | 19 |
| M_{H} | kg-cm | 49 (M_{H}^{∞}) | 38 (M_{H}^{∞}) | 39 (M_{H}^{∞}) | 38 (M_{H}^{∞}) |
| tₛ₂ | min | 1.2 | 8.5 | 6.4 | 6.2 |
| t_{c10} | min | 1.1 | 7.2 | 7.4 | 5.8 |
| t_{c90} | min | 14.0 | 18.5 | 21.2 | 21.2 |

Mechanical properties

| M₁₀₀ | MPa | 8.3 | 4.3 | 4.1 | 4.0 |
|---|---|---|---|---|---|
| T_{b} | MPa | 18.6 | 19.3 | 20.7 | 21.4 |
| E_{b} | % | 180 | 210 | 200 | 200 |
| hardness pts | | 72 | 70 | 70 | 68 |
| Compression set % | | | | | |
| 250° C., | 70 hr | 37 | 29 | 21 | — |
| 275° C., | 70 hr | 37 | 31 | | 28 |
| 295° C., | 70 hr | 45 | 35 | 40 | 33 |

Hot water resistance
test (200° C., 70 hr)
hardness change

| (IRHD) pts | | −1 | −2 | −2 | +2 |
|---|---|---|---|---|---|
| volume increase % | | +1.6 | +6.0 | +2.8 | +0.9 |
| | | Example | Example | Example | Example |
| Composition | | 9 | 10 | 11 | 12 |
| fluoroelastomer | | 100 | 100 | 100 | 100 |
| curing agent A | | 1.4 | 1.4 | 1.4 | 1.4 |
| barium sulfate | | | | | |
| wollastonite (1) | | | 10 | | |
| wollastonite (2) | | | | 10 | |
| silicon dioxide (1) | | | | | |
| silicon dioxide (2) | | | | | 5 |
| titanium (IV) oxide | | 10 | 10 | | 10 |
| iron (III) oxide | | | | 10 | |
| curing agent B | | | | | |
| γ-aminopropyltri- | | 1 | | | |
| methoxysilane | | | | | |
| vinyltris (β-methoxy- | | | | 1 | |
| ethoxy) silane | | | | | |
| γ-mercaptopropyltri- | | | 1 | | |
| methoxysilane | | | | | |
| γ-perfluoro ({1- (1- | | | | | 2 |
| methyl-2- | | | | | |
| proxy) ethoxy}prop- | | | | | |
| ionyl) aminopropyl | | | | | |
| trimethoxysilane | | | | | |
| ODR (24 min) @/° C. | | 220 | 220 | 220 | 200 |
| M_{L} | kg-cm | 23 | 21 | 20 | 24 |
| M_{H} | kg-cm | 29 (M ₕ^{∞}) | 33 (M _{H}^{∞}) | 31 (M _{H}^{∞}) | 29 (M _{H}^{∞}) |
| tₛ₂ | min | 5.2 | 9.8 | 8.4 | 10.2 |
| t_{c10} | min | 7.8 | 4.8 | 6.8 | 6.0 |
| t_{c90} | min | 17.8 | 22.3 | 22.0 | 18.3 |

Mechanical properties

| | | | | | |
|---|---|---|---|---|---|
| M | MPa | 4.1 | 9.4 | 10.6 | 7.6 |
| T_{b} | MPa | 17.8 | 17.0 | 20.8 | 18.4 |
| E_{b} | % | 220 | 160 | 170 | 170 |
| hardness | pts | 68 | 72 | 72 | 73 |

Compression set %

| | | | | | |
|---|---|---|---|---|---|
| 250° C., | 70 hr | 35 | 21 | 22 | 27 |
| 275° C., | 70 hr | 40 | 23 | 23 | 30 |
| 295° C., | 70 hr | 45 | 27 | 28 | 42 |

hot water resistance
test (200° C., 70 hr)
hardness change

| (IRHD) pts | | +1 | −1 | +1 | −2 |
|---|---|---|---|---|---|
| volume increase % | | +1.5 | +3.2 | +1.2 | +3.0 |
| | | Comp. | Comp. | Comp. | Comp. |
| Composition | | Ex. 1 | Ex. 2 | Ex. 3 | Ex. 4 |
| fluoroelastomer | | 100 | 100 | 100 | 100 |
| curing agent A | | 1.4 | 1.4 | 1.4 | |
| barium sulfate | | 10 | | | |
| wollastonite (1) | | | 10 | | |
| wollastonite (2) | | | | | |
| silicon dioxide (1) | | | | 10 | |
| silicon dioxide (2) | | | | | |
| titanium (IV) oxide | | | | | 10 |
| iron (III) oxide | | | | | |
| curing agent B | | | | | 1 |
| γ-aminopropyltri- | | | | | |
| methoxysilane | | | | | |
| vinyltris (β-methoxy- | | | | | |
| ethoxy) silane | | | | | |
| γ-mercaptopropyltri- | | | | | |
| methoxysilane | | | | | |
| ODR (24 min) @/° C. | | 220 | 220 | 220 | 190 |
| M_{L} | kg-cm | 22 | 26 | a) | 26 |
| M_{H} | kg-cm | 36 (M _{H}^{∞}) | 41 (M _{H}^{∞}) | | 33 (M _{H}^{∞}) |
| tₛ₂ | min | 7.4 | 3.4 | | 8.1 |
| t_{c10} | min | 7.4 | 3.0 | | 6.0 |
| t_{c90} | min | 21.2 | 20.0 | | 11.5 |

Mechanical properties

| | | | | | |
|---|---|---|---|---|---|
| M | MPa | b) | b) | b) | 2.9 |
| T_{b} | MPa | | | | 13.3 |
| E_{b} | % | | | | 220 |
| hardness | pts | | | | 67 |

Compression set %

| | | |
|---|---|---|
| 250° C., | 70 hr | 35 |
| 275° C., | 70 hr | 34 |
| 295° C., | 70 hr | 55 |

hot water resistance
test (200° C., 70 hr)
hardness change

| | |
|---|---|
| (IRHD) pts | −2 |
| volume increase % | +4.4 |

Note:
a) no torque increase recognized.
b) not moldable.

TABLE 2

| Composition | | Example 13 | Example 14 | Comp.Ex. 5 |
|---|---|---|---|---|
| fluoroelastomer | | 100 | 100 | 100 |
| curing agent A | | 1.4 | 1.4 | 1.4 |
| barium sulfate | | 10 | 10 | 10 |
| wollastonite (1) | | | | |
| wollastonite (2) | | | | |
| silicon dioxide (1) | | | | |
| silicon dioxide (2) | | | | |
| titanium (IV) oxide | | 10 | 10 | 10 |
| iron (III) oxide | | | | |
| curing agent B | | | | |
| γ-aminopropyltri- | | | | |
| methoxysilane | | | | |
| vinyltris (β-methoxy- | | 1 | | |
| ethoxy) silane | | | | |
| γ-mercaptopropyltri- | | | 1 | |
| methoxysilane | | | | |
| ODR (24 min) @/° C. | | 220 | 220 | 220 |
| M_{L} | kg-cm | 16 | 32 | 24 |
| M_{H} | kg-cm | 36 (M _{H}^{∞}) | 24 (M _{H}^{∞}) | 31 (M _{H}^{∞}) |
| tₛ₂ | min | 10.0 | 12.0 | 10.8 |
| t_{c10} | min | 8.0 | 8.8 | 4.8 |
| t_{c90} | min | 22.1 | 22.4 | 22.4 |

Mechanical properties

| | | | | |
|---|---|---|---|---|
| M | MPa | 5.1 | 5.3 | 6.0 |
| T_{b} | MPa | 20.4 | 19.2 | 16.5 |
| E_{b} | % | 200 | 190 | 190 |

| | | | |
|---|---|---|---|
| hardness pts | 70 | 71 | 71 |

Compression set %

| | | | | |
|---|---|---|---|---|
| 250° C., | 70 hr | 18 | 17 | 17 |
| 275° C., | 70 hr | 20 | 20 | 19 |
| 295° C., | 70 hr | 27 | 26 | 23 |

hot water resistance
test (200° C., 70 hr)
hardness change

| | | | |
|---|---|---|---|
| (IRHD) pts | +1 | −1 | −3 |
| volume increase % | +1.0 | +2.2 | +3.0 |
| Appearance of molding | ivory | ivory | blue |
| | | | uneven color |
| In-air heat aging test | | | |
| (295° C., 70 hr) | | | |
| M₁₀₀ change % | −17 | −16 | −18 |
| T_{b} change % | −7 | −11 | −12 |
| E_{b} change % | +15 | +16 | +16 |
| hardness change pts | −1 | −1 | −3 |
| weight change % | −0.4 | −0.4 | −0.3 |
| Oil resistance test | | | ] |
| BLEND ™770 | | | |
| (175° C., 70 hr) | | | |
| M₁₀₀ change % | −8 | −11 | −14 |
| T_{b} change % | −2 | −6 | −10 |
| E_{b} change % | +5 | +5 | +11 |
| hardness change pts | +2 | +1 | +2 |
| vol. increase % | +0.9 | +0.7 | +0.6 |
| SKYDROL ™LD-4 | | | |
| (125° C., 70 hr) | | | |
| M₁₀₀ change % | −24 | −33 | −27 |
| T_{b} change % | −16 | −40 | −21 |
| E_{b} change % | +5 | −5 | +16 |
| hardness change pts | −1 | −2 | −2 |
| vol. increase % | +4.2 | +4.9 | +7.8 |

What is claimed is:

1. A fluoroelastomer composition comprising:
1) a fluoroelastomer consisting essentially of tetrafluoroethylene units, perfluoro(alkyl vinyl ether) units and cyano group containing perfluorovinyl ether units, provided that the alkyl of the perfluoro (alkyl vinyl ether) has 1 to 5 carbon atoms;
2) at least one silane coupling agent selected from among compounds represented by the following general formula (I) or (II): 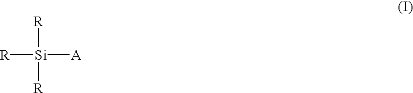
wherein each of R represents an alkoxy or alkyl group having 1 to 5 carbon atoms, said alkoxy or alkyl group having a chain in which at least one ether bond may be contained, provided that at least two of the R are alkoxy groups, and
A represents an alkyl group having 1 to 10 carbon atoms, to which at least one functional group selected from the group consisting of an amino group, a mercapto group, an epoxy group, a vinyl group, a methacryloxy group and halogens is bonded, 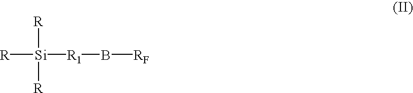
wherein each of R represents an alkoxy or alkyl group having 1 to 5 carbon atoms, said alkoxy or alkyl group having a chain in which at least one ether bond may be contained, provided that at least two of the R are alkoxy groups,
R₁ represents an alkylene group having 1 to 10 carbon atoms, optionally containing a sulfide group, an ether group or a nitrogen atom bonded with a carbonyl group or sulfonyl group, said carbonyl or sulfonyl group having a chain optionally containing R_{F} defined below,
B represents: 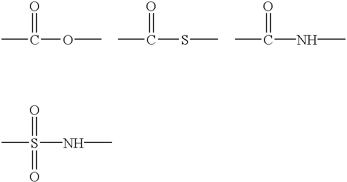
or a carbon to carbon bond directly bonding R₁ with R_{F}, and
R_{F} is a perfluoroalkyl group having 1 to 10 carbon atoms;
3) a crosslinking agent; and
4) an inorganic filler.

2. The fluoroelastomer composition as claimed in claim 1, wherein the crosslinking agent is represented by the general formula (III): 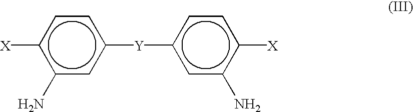
wherein Y represents an alkylidene group having 1 to 6 carbon atoms, a perfluoroalkylidene group having 1 to 10 carbon atoms, a group of the formula —SO₂—, —O— or —C(═O)—, or a carbon to carbon bond directly bonding two benzene rings together, and X represents a hydroxyl group or an amino group.

3. The fluoroelastomer composition as claimed in claim 1, wherein the crosslinking agent is represented by the general formula (IV): 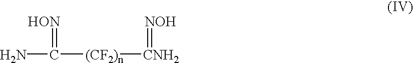
wherein n is an integer of 1 to 10.

4. The fluoroelastomer composition as claimed in claim 1, wherein the crosslinking agent is represented by the general formula (V): 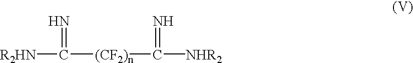
wherein R₂ represents H or NH₂, and n is an integer of 1 to 10.

5. The fluoroelastomer composition as claimed in claim 1, wherein the crosslinking agent is represented by the general formula (VI): 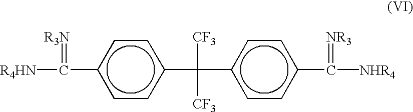
wherein R₃ represents OH or H, and R₄ represents H or NH₂.

6. The fluoroelastomer composition as claimed in claim 1, wherein the inorganic filler is at least one member selected from the group consisting of titanium dioxide, ferric oxide, zinc oxide, magnesium oxide, aluminum oxide, silicon dioxide, calcium silicate, aluminum silicate, magnesium silicate, barium sulfate, calcium sulfate, calcium carbonate, magnesium carbonate and barium carbonate.
